(19) United States
(12) Patent Application Publication
(10) Pub. No.: US 2013/0222788 A1
(43) Pub. Date: Aug. 29, 2013

(54) ROUGHNESS EVALUATING APPARATUS, AND OBJECT EVALUATING APPARATUS AND ROUGHNESS EVALUATING METHOD USING THE SAME

(71) Applicant: CANON KABUSHIKI KAISHA, (US)

(72) Inventors: Kousuke Kajiki, Tokyo (JP); Oichi Kubota, Kawasaki-shi (JP)

(73) Assignee: CANON KABUSHIKI KAISHA, Tokyo (JP)

(21) Appl. No.: 13/772,278

(22) Filed: Feb. 20, 2013

Related U.S. Application Data
(63) Continuation-in-part of application No. 13/685,538, filed on Nov. 26, 2012.

(30) Foreign Application Priority Data
Feb. 23, 2012 (JP) 2012-037487
Jan. 30, 2013 (JP) 2013-015053

(51) Int. Cl. G01B 11/30

(52) U.S. Cl. CPC G01B 11/303
USPC 356/51; 356/600; 356/73

(57) ABSTRACT

Provided is a roughness evaluating apparatus including: a generating unit configured to generate an electromagnetic wave pulse; a detecting unit configured to detect the electromagnetic wave pulse from a sample to which the electromagnetic wave pulse is irradiated; a time waveform calculating unit configured to calculate a time waveform of the electromagnetic wave pulse from the sample detected by the detecting unit; and a processing unit configured to obtain roughness information on an internal interface of the sample from the time waveform of the electromagnetic wave pulse, wherein the processing unit extracts a part corresponding to the internal interface in the time waveform of the electromagnetic wave pulse from the time waveform of the electromagnetic wave pulse to obtain the roughness information on the internal interface.

### CROSS-REFERENCE TO RELATED APPLICATIONS

This application is a continuation-in-part of U.S. patent application Ser. No. 13/685,538 filed on Nov. 26, 2012, which claims the benefit of Japanese Patent Application No. 2012-037487. This application also claims the benefit of Japanese Patent Application No. 2013-015053, filed Jan. 30, 2013.

### BACKGROUND OF THE INVENTION

1. Field of the Invention

The present invention relates to a roughness evaluating apparatus for measuring a shape of an object, especially, roughness of an object, by using an electromagnetic wave pulse. Further, the present invention relates to an object evaluating apparatus for obtaining information on an object by using an electromagnetic wave pulse, and a roughness evaluating method of measuring roughness of an object by using an electromagnetic wave pulse.

2. Description of the Related Art

Various apparatuses have been developed in order to measure surface roughness of an object by using electromagnetic waves. The apparatuses have been widely applied to various fields, such as evaluation of a product or a medical field. Optics Letters, 34, 1927 (2009) suggests an apparatus for evaluating surface roughness of a metal by using a reflection spectrum of electromagnetic waves. In Optics Letters, 34, 1927 (2009), surface roughness of a metal is evaluated by using Equation 1 below in which a good approximation is obtained when a size of surface roughness for a wavelength of electromagnetic waves is sufficiently small.

R_{rough}=Rₛₘₒₒₜₕexp[−(4ππk cos θ)²] (Equation 1)

Here, R_{rough} is a reflectance in regular reflection from a rough surface, Rₛₘₒₒₜₕ is a reflectance in regular reflection from a smooth surface, σ is surface roughness (rms), k is a wave number, and θ is an incident direction of electromagnetic waves. According to Equation 1, it may be identified that as a frequency or roughness increases, a regular reflection component decreases. In the frequency spectrum, surface roughness σ may be calculated by fitting measured data and a curved line of Equation 1. Here, surface roughness of, for example, approximately 16 μm is evaluated by using electromagnetic waves at a frequency region around 1 THz.

Further, Japanese Patent Application Laid-Open No. 2011-22011 relates to an apparatus for evaluating a physical property of a sample by using electromagnetic waves, and discloses an apparatus for evaluating roughness of a sample by using transmission angle distribution of electromagnetic waves. In an example of this apparatus, the apparatus includes a plurality of electromagnetic wave detecting units so as to detect electromagnetic waves transmitting a sample at a plurality of angles. Roughness of the sample is evaluated from the obtained angle distribution of the electromagnetic waves by using a tendency that as roughness of a sample is large, the angle distribution of the electromagnetic waves is widened. It is known that roughness may be evaluated from a reflection angle distribution in a reflection arrangement in which an electromagnetic wave is reflected from a sample, similarly to a transmission arrangement in which an electromagnetic wave passes through a sample. As described above, various roughness evaluating apparatuses using electromagnetic waves have been generally known.

However, in the apparatus disclosed in Japanese Patent Application Laid-Open No. 2011-22011 or Optics Letters, 34, 1927 (2009), there is a case in that when electromagnetic waves for evaluating roughness are affected by an object, accuracy of the measurement of roughness is deteriorated.

### SUMMARY OF THE INVENTION

An exemplary embodiment of the present invention provides a roughness evaluating apparatus including: a generating unit configured to generate an electromagnetic wave pulse; a detecting unit configured to detect the electromagnetic wave pulse from a sample to which the electromagnetic wave pulse is irradiated; a time waveform calculating unit configured to calculate a time waveform of the electromagnetic wave pulse from the sample detected by the detecting unit; and a processing unit configured to obtain roughness information on an internal interface of the sample from the time waveform of the electromagnetic wave pulse, wherein the processing unit extracts a part corresponding to the internal interface in the time waveform of the electromagnetic wave pulse from the time waveform of the electromagnetic wave pulse to obtain the roughness information on the internal interface.

The roughness evaluating apparatus according to the exemplary embodiment of the present invention extracts information on a part corresponding to a target portion for evaluation from an electromagnetic wave for evaluating roughness, so that it is possible to measure or evaluate roughness with high accuracy.

Further features of the present invention will become apparent from the following description of exemplary embodiments with reference to the attached drawings.

### BRIEF DESCRIPTION OF THE DRAWINGS

FIG. 1 is a diagram illustrating a configuration example of a first embodiment of a roughness evaluating apparatus according to the present invention.

FIG. 2 is a diagram illustrating a configuration example of a first embodiment of a roughness evaluating apparatus according to the present invention.

FIG. 3 is a diagram illustrating a configuration example of a first embodiment of a roughness evaluating apparatus according to the present invention.

FIG. 4 is a diagram illustrating an example of a structure around a sample for describing a processing method according to the present invention.

FIG. 5 is a diagram illustrating an example of a processing flow for describing a processing method according to the present invention.

FIG. 6 is a graph illustrating an example of a reflected light intensity distribution.

FIG. 7 is a diagram illustrating an example of a change in a reflection angle by a surface of a sample.

FIG. 8 is a diagram illustrating an example of a change in a reflection angle by a surface of a sample.

FIG. 9 is a diagram illustrating an example of a structure around a sample for describing a processing method according to the present invention.

FIG. 10 is a diagram illustrating a configuration example of a third embodiment of an object evaluating apparatus according to the present invention.

FIG. 11A is a schematic diagram illustrating a figure of an interface between an epidermis and dermis (normal state) of skin.

FIG. 11B is a schematic diagram illustrating a figure of an interface between an epidermis and dermis (disease state) of skin.

FIG. 12 is a diagram illustrating an example of a processing flow for describing a processing method according to the present invention.

### DESCRIPTION OF THE EMBODIMENTS

Preferred embodiments of the present invention will now be described in detail in accordance with the accompanying drawings.

A roughness evaluating apparatus and method of the present invention is characterized by extracting a part corresponding to an internal interface in a time waveform of an electromagnetic wave pulse from the sample from the time waveform of the electromagnetic wave pulse, in obtaining roughness information on an internal interface of a sample (a target object to be measured). Further, the roughness evaluating apparatus and method of the present invention may also be configured such that influence of another object on an electromagnetic wave for evaluating roughness of the internal interface is corrected. The influence of the object on the electromagnetic wave includes, for example, refraction, scattering, absorption, Fresnel loss, a temporal overlap between a reflection pulse of a surface and a reflection pulse of an internal interface, and the like according to the passing through a surface of the object when roughness of an internal interface of an object is measured.

An object evaluating apparatus may include the roughness evaluating device and may be configured such that a processing means obtains information other than roughness, together with roughness information on an internal interface of a sample. In this case, the processing means may be configured so as to obtain the information other than roughness by correcting the influence of the internal interface exerted on the electromagnetic wave pulse by using the obtained roughness information on the internal interface.

Further, an object evaluating apparatus may include the roughness evaluating device and a processing means for obtaining information other than roughness, together with roughness information on an internal interface of a sample, to evaluate a state of skin. In this case, the processing means has a function of comparing roughness information on a part corresponding to an internal interface in a time waveform of an electromagnetic wave pulse with reference data to obtain roughness of the internal interface. The reference data preserves a relation between roughness of an internal interface and a spectrum of an electromagnetic wave pulse, or a relation between roughness of an internal interface and a reflection angle distribution of an electromagnetic wave pulse. Further, the electromagnetic wave pulse includes a frequency of a terahertz band, and the reference data includes measured data about a health condition or a disease of skin, and a state of the skin is estimated by comparing the reference data and the obtained data.

Hereinafter, exemplary embodiments of the present invention will be described by using the drawings.

### First Embodiment

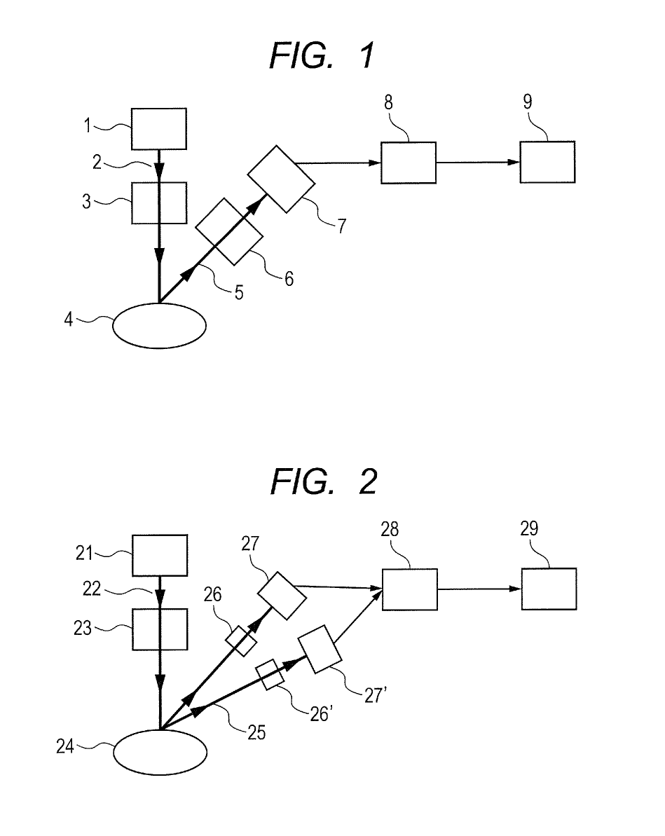

A roughness evaluating apparatus and method that is a first embodiment of the present invention will be described with reference to FIG. 1. In FIG. 1, an electromagnetic wave pulse 2 generated by a generating means 1 is irradiated to a sample 4 by an irradiation optical system 3. A reflected electromagnetic wave pulse 5 from the sample 4 is incident to a detecting means 7 by a light receiving optical system 6. A time waveform calculating means 8 calculates a time waveform of electric field intensity of the reflected electromagnetic wave pulse 5 by using information on the reflected electromagnetic wave pulse 5 detected by the detecting means 7. A processing means 9 obtains roughness information on an internal interface of the sample 4 by processing the time waveform. Here, a pulse reflected by the internal interface of the sample 4 (a pulse reflected by a surface of which roughness is desired to be measured; hereinafter, referred to as a “pulse for evaluating roughness”) and a pulse reflected from a surface other than the interface compose a pulse train to be incident to the detecting means 7. The pulse for evaluating roughness contains roughness information on an interface, and thus roughness may be evaluated by using the pulse for evaluating roughness. A method of evaluating roughness of an interface will be described below.

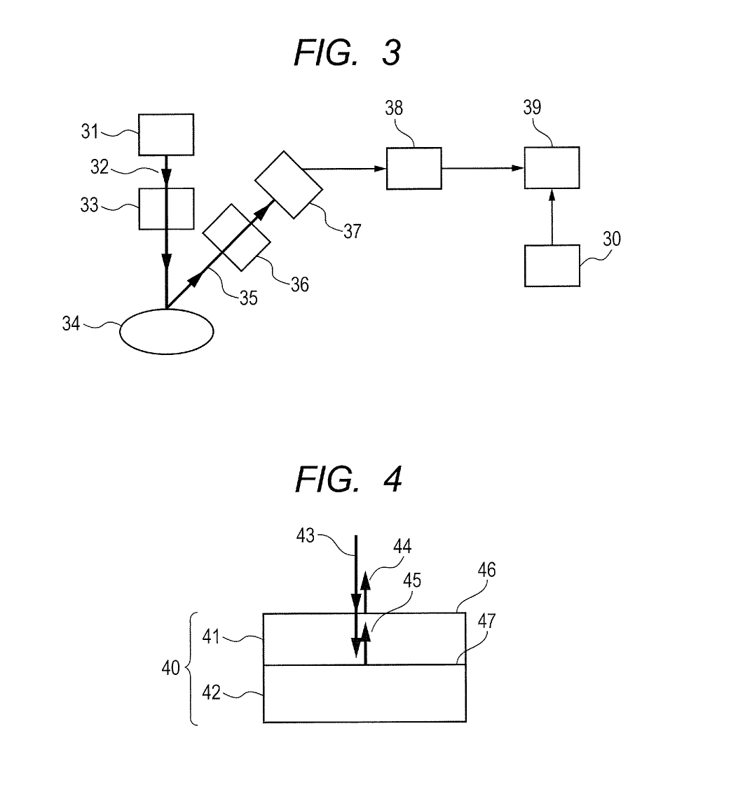

The method of evaluating roughness of an interface includes a method of calculating roughness from a reflection angle distribution of the reflected electromagnetic wave pulse 5 or a method of calculating roughness from a spectrum of the reflected electromagnetic wave pulse 5. In the method of calculating roughness from a reflection angle distribution of the reflected electromagnetic wave pulse 5, the reflected electromagnetic wave pulse 5 reflected from the sample 4 may be detected at a plurality of angles. Specifically, a plurality of light receiving optical systems 6 and detecting means 7, or a plurality of generating means 1 and irradiation optical systems 3 are provided. Otherwise, the generating means 1 and the irradiation optical system 3, or the sample 4, or the light receiving optical system 6 and the detecting means 7 may be configured so as to rotate with respect to a vicinity of a measurement place of the sample 4 as an axis. In the meantime, FIG. 2 illustrates, as an example, a configuration of the apparatus including two pairs of light receiving optical systems and detecting means, such as a pair of light receiving optical systems 26 and 26′, and a pair of detecting means 27 and 27′. Other parts (denoted by numbers of the 20s) are the same as those of FIG. 1. As described above, in the present exemplary embodiment, the detecting means detects the electromagnetic wave pulse incident to the sample at a plurality of angles (for example, in a case of a configuration in which the sample rotates with respect to the vicinity of the measurement place of the sample as an axis) or the electromagnetic wave pulse reflected from the sample at a plurality of angles. Further, the processing means obtains roughness information on the internal interface from the reflection angle distribution of the electromagnetic wave pulse.

In the method of calculating roughness from a spectrum of the reflected electromagnetic wave pulse 5 that is a reflected component of the electromagnetic wave pulse from the internal interface, it is sufficient that the number of angles for detecting the reflected electromagnetic wave pulses 5 reflected from the sample 4 is one, so that there is a merit of achieving a simpler configuration. However, when the pulse for evaluating roughness and the pulse reflected from the surface of the object are detected while temporally overlapping each other, it is necessary to draw attentions to the deterioration of accuracy of the measurement of the spectrum of the pulse for evaluating roughness. The overlap is remarkably exhibited in a case where a time interval between the two pulses is equal to or less than a pulse width (FWHM) of the pulse. In addition, there is a case in which a signal is represented over a range of several tens of ps later than a pulse peak by moisture in the air, absorption of the electromagnetic waves in the sample, or the like.

A method of calculating and obtaining roughness will be described. The evaluation of roughness may be performed by comparing reference data 30 (illustrated in FIG. 3, other parts (denoted by numbers of the 30s) illustrated in FIG. 3 are the same as those of FIG. 1) and actually measured data (actually measured data of the rough information on a part corresponding to the internal interface in the time waveform of the electromagnetic wave pulse) by using a theory equation representing a relation with the reflection angle distribution or the spectrum of the reflected electromagnetic wave pulse. The reference data 30 is data (relation data between the roughness of the internal interface and the spectrum or the reflection angle distribution of the electromagnetic wave pulse) pre-obtained by measuring the reflection angle distribution or the spectrum of the reflected electromagnetic wave pulse for a plurality of samples having different roughness of the internal interface. For example, a degree of matching between the actually measured data and the reference data is calculated, and a value of roughness information related to the reference data 30 having the highest degree of matching may be roughness of the sample 4.

When a shape or a complex refractive index of an object according to the passing of the electromagnetic wave pulse 2 in the sample 4 is changed between a time of obtaining the reference data 30 and a time of evaluating and measuring the roughness, it is necessary to correct the reference data 30 (or the actually measured data as described below) by detecting the change. In order to detect the change, a pulse reflected from other surfaces, other than the surface of which the roughness is evaluated, and the like may be used. Further, even when the reference data does not include influence of a material, other than the interface, the processing means may process a part corresponding to the internal interface in the time waveform of the actually measured electromagnetic wave pulse so as to correct the influence of the material other than the internal interface.

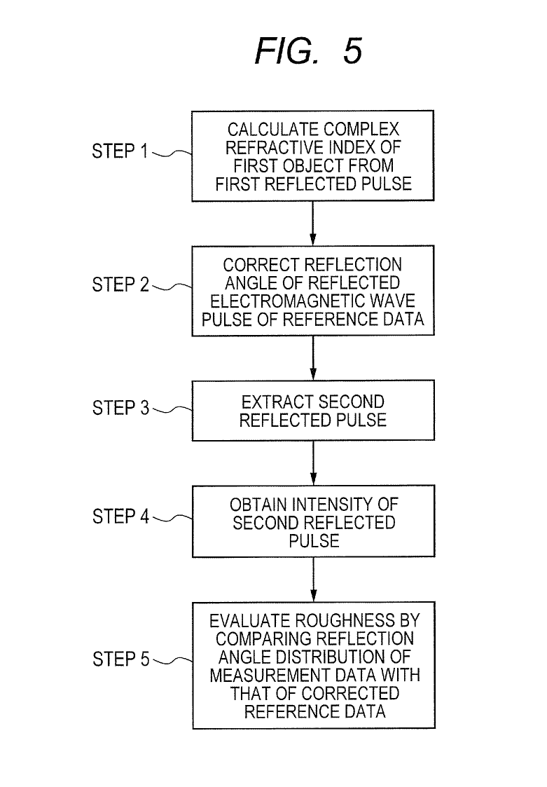

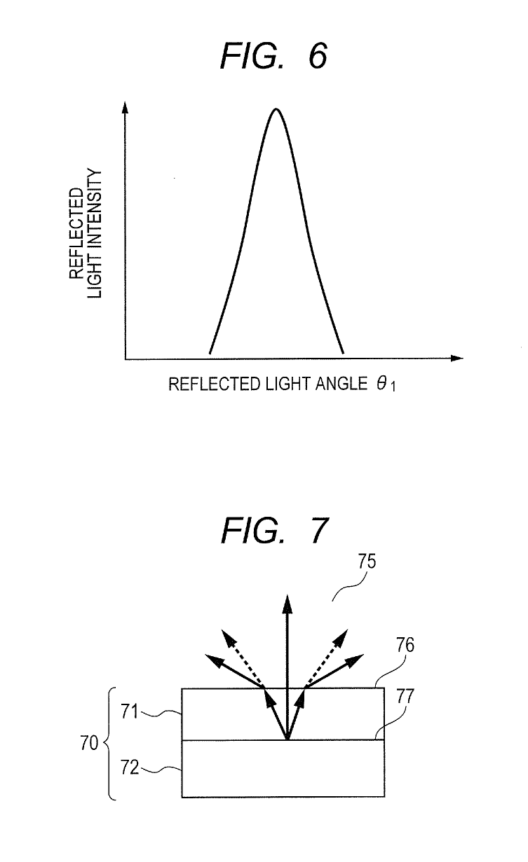

Next, a method of the correction will be described. First, a case of calculating roughness of an internal interface using a reflection angle distribution will be described. It is assumed that an electromagnetic wave pulse 43 is incident to a sample 40 as illustrated in FIG. 4. The sample 40 includes a first object 41 and a second object 42. It is assumed that an interface between the air and the first object 41 is referred to as a surface 46, and an interface between the first object 41 and the second object 42 is referred to as an internal interface 47. It is assumed that among reflected waves of the electromagnetic wave pulse 43, a reflected wave reflected from the surface 46 is referred to as a surface reflected pulse 44, and a reflected wave reflected from the internal interface 47 is referred to as an internal interface reflected pulse 45. When a refractive index of the first object 41 is changed, roughness may be evaluated according to a processing flow illustrated in FIG. 5. A reason of the change in the refractive index includes a case in which a sample itself changes in time series, a case in which imaging is performed by scanning the sample, or the like. Here, in order to help the understanding, it is considered that the electromagnetic wave pulse 43 is vertically incident to the surface 46 of the sample 40. Further, the reference data of the reflection angle distribution is included as illustrated in FIG. 6, but it is assumed that the refractive index of the first object 41 is changed in the evaluation of roughness, compared to the obtainment of the reference data. It is assumed that the reference data has a group of reflection angle distribution data measured for a plurality of standard samples having different roughness of the internal interface 47.

Hereinafter, the processing flow of FIG. 5 will be described.

(Step 1)

First, the surface reflected pulse 44 reflected from the surface 46 is extracted from a detection time waveform. When the surface reflected pulse 44 is sufficiently separated from the internal interface reflected pulse 45 in terms of a time, it is sufficient to simply separate the surface reflected pulse 44 from the internal interface reflected pulse 45 at any one time on a time axis. When the surface reflected pulse 44 and the internal interface reflected pulse 45 have an overlap part, the surface reflected pulse 44 may be separated from the internal interface reflected pulse 45 by using an analysis method, such as a regression analysis or a wavelet transform, so as to decrease interaction. For example, it is assumed that a pulse width (FWHM) of the electromagnetic wave pulse 43 is 300 fs. In this case, when an interval between the surface 46 and the internal interface 47 is approximately 50 μm (corresponding to 100 μm back and forth) or less based on a length of an optical path, overlap between the respective reflected pulses 44 and 45 increases, so that the use of the aforementioned separation method is demanded.

The complex refractive index of the first object 41 is calculated by Equations 2 and 3 below from the surface reflected pulse 44 extracted as described above (see TERAHERTZ SENSING TECHNOLOGY Volume 1 (World Scientific)).

$$\begin{matrix}{n}_{s} ( ω ) = \sqrt{{ɛ}_{s} ( ω )} & ( Equation 2 ) \\ {ɛ}_{s} ( ω ) = [ {sin}^{2} {θ}_{i} + {cos}^{2} {{θ}_{i} ( \frac{1 - r ( ω )}{1 + r ( ω )} )}^{2} ] {ɛ}_{1} ( ω ) & ( Equation 3 )\end{matrix}$$

Here, nₛ(ω) is a complex refractive index of a target object (here, the first object 41), ∈ₛ(ω) is a complex dielectric constant of a target object, ∈₁(ω) is a complex dielectric constant of an object (here, the air) in an incident side, r(ω) is a complex reflectance, θᵢ is an incident angle of an electromagnetic wave, and ω is an angular frequency of an electromagnetic wave.

(Step 2)

Step 2 will be described with reference to FIG. 7. Respective parts denoted by numbers of the 70s illustrated in FIG. 7 are the same as those indicated by numbers of the 40s illustrated in FIG. 4. An angle of an internal interface reflected pulse 75 emitted to the outside of a sample 70 is corrected by using a refractive index of a first object 71. Since a partial component of the internal interface reflected pulse 75 is inclinedly incident to a surface 76 from an internal interface 77, an emission angle is calculated by substituting a refractive index to a Snell's equation representing a relation between an incident angle and an emission angle of an electromagnetic wave. A dotted line in FIG. 7 represents an example of a change in an emission angle of the internal interface reflected pulse 75 when the refractive index of the first object 71 is changed. When a refractive index n1 in the obtainment of the reference data is changed to n1′ in the evaluation of the roughness, a relation like Equation 6 may be derived from the Snell's equation (Equations 4 and 5) at each time point.

$$\begin{matrix}{n}_{1} sin {θ}_{1} = sin {θ}_{0} & ( Equation 4 ) \\ {n}_{1}^{′} sin {θ}_{1} = sin {θ}_{0}^{′} & ( Equation 5 ) \\ {θ}_{0}^{′} = arcsin ( \frac{{n}_{1}^{′}}{{n}_{1}} sin {θ}_{0} ) & ( Equation 6 )\end{matrix}$$

According to Equation 6, for example, when a refractive index is 2.2 and a part of the electromagnetic wave is emitted to the outside of the object at an angle of 20 degrees, the electromagnetic wave is emitted at an angle of 18 degrees in a case where the refractive index is changed to 2. The angle may be corrected by substituting a horizontal axis θ1 of a graph of FIG. 6 with θ1′ according to Equation 6. When the shape of the sample surface is obtained by scanning the sample 70 and the like, the above-described Snell's equation may be applied in consideration of the fact that a normal vector of the surface is determined by the shape of the surface. Accordingly, the reflection angle can be corrected. Further, when the absorption coefficient is changed, a length of an optical path of the internal interface reflected pulse 75 in the first object 71 is calculated, influence of absorption is calculated, and then the influence is removed from an intensity of the internal interface reflected pulse 75 in the obtainment of the reference data. That is, an absorption portion is subtracted from electric field intensity in the reflection angle distribution. Further, regarding a refractive index or an absorption coefficient used in the present step, a reflective index or an absorption coefficient corresponding to only an important part of the wavelength included in the electromagnetic wave pulse may be used. A reflective index or an absorption coefficient for the entire wavelength included in the electromagnetic wave pulse may be used as a matter of course.

(Step 3)

The internal interface reflected pulse 45 is separated from the surface reflected pulse 44 in the time waveform and then is extracted in order to be used in the evaluation of the roughness. As mentioned in step 1, when the respective pulses have the overlap part, the respective pulses may be separated from each other so as to decrease the interaction by using the analysis method, such as the regression analysis or the wavelet transform.

(Step 4)

An intensity of the internal interface reflected pulse 45 is obtained. For example, a peak electric field intensity in the time waveform is obtained at a plurality of reflection angles.

(Step 5)

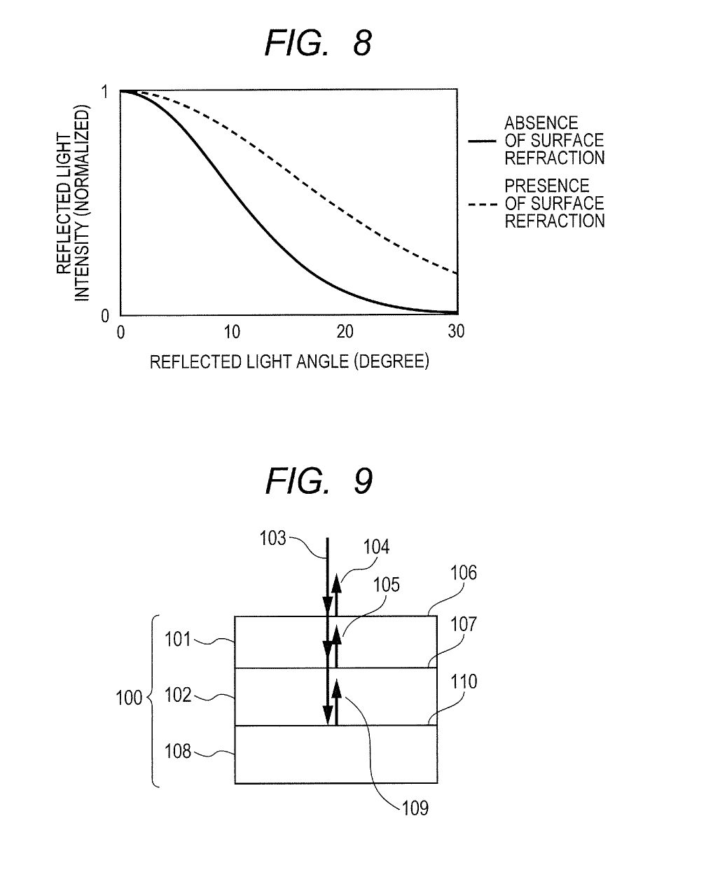

The peak electric field intensity of the internal interface reflected pulse 45 at the plurality of reflection angles obtained in step 4 is compared with the reference data corrected in step 2, so that roughness of the internal interface 47 is determined from data having the highest degree of matching. According to the processing flow, the influence of the first object 41 exerted on the internal interface reflected pulse 45 may be decreased. Influence of surface refraction exerted on the reflection angle distribution will be described below with reference to a more specific example. FIG. 8 represents an example of the reflection angle distribution when there is influence of refraction by a surface and there is no influence of refraction by a surface. In the meantime, FIG. 8 is an example of a curved line of a theory of the reflection angle distribution in which a case where there is influence of surface refraction is compared with a case where there is no influence of surface refraction based on the theory equation described in Japanese Patent No. 03276577. Here, a refractive index of the object is 1.7, a wavelength of an electromagnetic wave is 300 μm, and Rrms/m is 300 μm (Rrms: root-mean-square roughness of interface roughness, m: root-mean-square of inclination angle distribution of the interface). As can be seen from FIG. 8, the reflection angle distribution becomes wide according to the influence of the surface refraction. A degree of the widening depends on the refractive index of the first object 41, so that the reference data may be corrected according to the value thereof. Although the reference data is corrected herein, the measurement data is corrected with a condition in the obtainment of the reference data, and then the corrected measurement data may be compared with the reference data.

Further, herein, the complex refractive index of the first object 41 is calculated from the surface reflected pulse 44, but the complex refractive index of the first object 41 may be possessed as database in advance. When the reflection angle is corrected by considering the shape of the surface 46 of the first object 41, the shape of the surface 46 of the first object 41 may be possessed as database in advance.

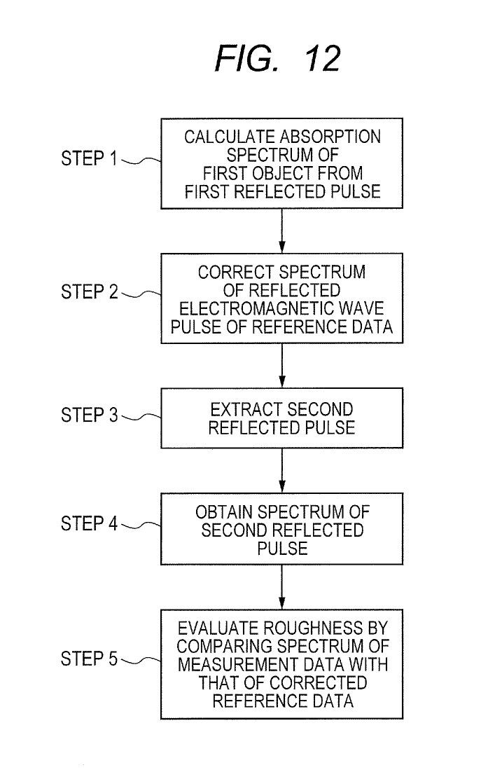

Next, in a case of calculating roughness of an internal interface using a spectrum, a method of correcting influence of a material other than the internal interface will be described below. An assumed sample is the same as that of FIG. 4. A processing flow illustrated in FIG. 12 will be described below. The description of the same part as that in the processing flow of FIG. 5 will be omitted.

(Step 1)

Step 1 is the same as step 1 of FIG. 5. However, it is only required to recognize the absorption coefficient spectrum here.

(Step 2)

In this step, the previously obtained reference data (data of the relation between the roughness and the spectrum of the reflected electromagnetic wave pulse) is corrected. Specifically, the amount of absorption of the portion of the length of the optical path is removed from the electric field intensity of the spectrum of the reference data using the absorption coefficient spectrum of the first object 41 obtained in step 1. Incidentally, regarding the absorption coefficient used in the present step, the absorption coefficient corresponding to only an important part of the wavelength included in the electromagnetic wave pulse may be used. The absorption coefficient for the entire wavelength included in the electromagnetic wave pulse may be used as a matter of course.

(Step 3)

Step 3 is the same as step 3 of FIG. 5.

(Step 4)

A spectrum of the internal interface reflected pulse 45 is obtained.

(Step 5)

The spectrum of the internal interface reflected pulse 45 obtained in step 4 is compared with the reference data corrected in step 2, and the roughness of the internal interface 47 is determined from the data having the highest degree of matching.

Influence of an object exerted on an electromagnetic wave for evaluating roughness may be corrected by the roughness measuring apparatus and method as described above, so that roughness may be measured with high accuracy.

### Second Embodiment

A second embodiment relates to an object evaluating apparatus which corrects information, other than the roughness evaluated surface inside the object, by using information on the evaluated roughness. The apparatus and the method described in the first embodiment may be used in the evaluation of the internal interface. Descriptions of parts overlapping those of the first embodiment will be omitted. FIG. 9 is a diagram for describing a processing method in the present exemplary embodiment. Respective parts denoted by numbers of the 100s illustrated in FIG. 9 are the same as those indicated by numbers of the 40s illustrated in FIG. 4. FIG. 9 is a diagram of a case in which an electromagnetic wave pulse 103 is incident to a sample 100 in which a third object 108 is added to the sample of FIG. 4, and a third reflected pulse 109 is generated by a third surface 110. In FIG. 9, the third reflected pulse 109 is influenced by a second surface 107 (referred to as a roughness evaluated surface). For example, the third reflected pulse 109 is influenced by decrease of an electromagnetic wave transmission intensity or a change in a spectrum according to scattering by the second surface 107. Accordingly, in order to evaluate a shape of the third surface 110 or a physical property of the third object 108 with high accuracy, the influence of the roughness of the second surface 107 may be removed.

An incident light intensity I of the electromagnetic wave for a certain surface is the same as a sum of a transmitted light intensity T, a scattered light intensity S, and a reflected light intensity R. Accordingly, if a condition of the reflection and the scattering in the second surface 107 may be recognized through the method described in the first embodiment, a transmitted light intensity of the surface may be calculated. In the example of FIG. 9, the electromagnetic wave pulse 109 reflected from the third surface 110 transmits the second surface 107 two times. In this case, the aforementioned correction is performed two times.

The influence of the roughness of the internal interface may be corrected in the evaluation of the object by the aforementioned object evaluating apparatus, so that the object (for example, the shape of the third surface 110 or the physical property of the third object 108) may be evaluated with high accuracy. Accordingly, the object evaluating apparatus including the roughness evaluating device and the processing means, which obtains information other than the roughness, together with roughness information on a predetermined internal interface of a sample may be implemented.

### Third Embodiment

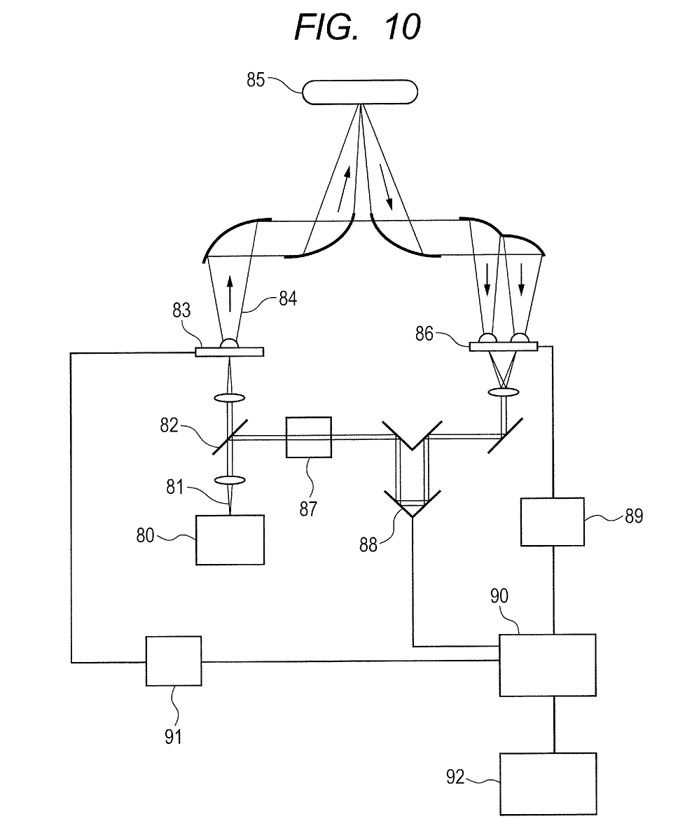

A third embodiment relates to an object evaluating apparatus having a function of the roughness evaluating apparatus described in the first and second embodiments. FIG. 10 illustrates a configuration example of the object evaluating apparatus in the present exemplary embodiment. The object evaluating apparatus is a terahertz time domain spectroscopy (THz-TDS) apparatus using a terahertz wave including an electromagnetic wave component in a frequency domain of about 30 GHz to 30 THz.

In FIG. 10, an excitation light pulse generating unit 80 emits an excitation light pulse 81. As the excitation light pulse generating unit 80, an optical fiber laser and the like may be used, and the excitation light pulse 81 herein is a pulsed laser of a band of wavelength of 1.5 μm and a pulse time width (full width at half maximum in power indication) of about 30 fs. The excitation light pulse 81 is divided into two sides by a beam splitter 82. One excitation light pulse 81 is incident to an electromagnetic wave pulse generating element 83, and the other excitation light pulse 81 is incident to a second harmonic generating unit 87. The electromagnetic wave pulse generating element 83 includes a photoconductive element and a silicon hemispheric lens. The photoconductive element includes a photoconductive layer for generating an optical excitation carrier by absorbing the excitation light pulse 81, an electrode for applying an electric field to the photoconductive layer, and an antenna for radiating the generated electromagnetic wave pulse 84. The electromagnetic wave pulse 84 is generated according to acceleration of the optical excitation carrier by the electric field. Since the electromagnetic wave pulse 84 is strongly radiated in a direction of a rear surface of a substrate on which the photoconductive element is formed, the silicon hemispheric lens is disposed to be adjacent to the rear surface of the substrate, thereby improving radiant power for a space. Herein, a wavelength of the excitation light pulse 81 is a band of 1.5 μm, so that as the photoconductive layer, a low-temperature grown InGaAs capable of generating the optical excitation carrier by absorbing the excitation light of the wavelength is used. A voltage source 91 applies a voltage to an electrode of the photoconductive element.

Through the aforementioned configuration, it is generally possible to radiate the electromagnetic wave pulse 84 of a pulse time width (full width at half maximum) of several hundreds of fs and up to several THz in a frequency domain. The electromagnetic wave pulse 84 radiated to the space is collected to the sample 85 by an optical element, such as a lens or a mirror. The electromagnetic wave pulse 84 reflected from the sample 85 is incident to an electromagnetic wave pulse detecting element 86 by the optical element. The electromagnetic wave pulse detecting element 86 is disposed so as to detect the electromagnetic wave pulses 84 reflected from the sample 85 at two different angles.

The other excitation light pulse 81 divided by the beam splitter 82 and incident to the second harmonic generating unit 87 is a pulsed laser of a band of a wavelength of 0.8 μm by a process of converting the second harmonic. A second harmonic conversion element may use a periodically poled lithium niobate (PPLN) crystal and the like. A wavelength generated during other nonlinear processes or a laser of a band of a wavelength of 1.5 μm emitted without wavelength conversion is excluded from the excitation light pulse 81 by a dichroic mirror and the like. The excitation light pulse 81 converted to a band of a wavelength of 0.8 μm is incident to the electromagnetic wave pulse detecting element 86 by passing through an excitation light delaying system 88. The electromagnetic wave pulse detecting element 86 may use an array of two elements having a configuration similar to that of the electromagnetic wave pulse generating element 83. The excitation light pulse 81 is divided into two sides again and incident to each element in response to the two elements. In the detection side, in order to absorb the excitation light pulse 81 of the band of the wavelength of 0.8 μm generated in the second harmonic generating unit 87, low-temperature grown GaAs is appropriately used in the photoconductive layer. The optical excitation carrier generated in the photoconductive layer is accelerated by an electric field of the electromagnetic wave pulse 84 to generate a current between electrodes. The current is converted to a voltage by a current-voltage converting unit 89. A value of the voltage reflects an intensity of the electric field of the electromagnetic wave pulse 84 within a time for which a photocurrent flows. A time waveform of the intensity of the electric field of the electromagnetic wave pulse 84 may be reconfigured by sweeping a delay time of the excitation light pulse 81 by the excitation light delaying system 88. A processing unit 90 controls the voltage of the electromagnetic wave pulse generating element 83 or the delay time by the excitation light delaying system 88, or evaluates the object by using the roughness evaluating method or the object evaluating method described in the first and second embodiments. Further, the processing unit 90 obtains information (a complex refractive index, a shape, or the like) on the sample 85 from the time waveform or the frequency component of the electromagnetic wave pulse 84, and displays the obtained information on a display unit 92. Tomographic imaging and the like may be performed by scanning a measurement place of the sample 85. The identification or the imaging of the object may be performed with high accuracy by the aforementioned object evaluating apparatus.

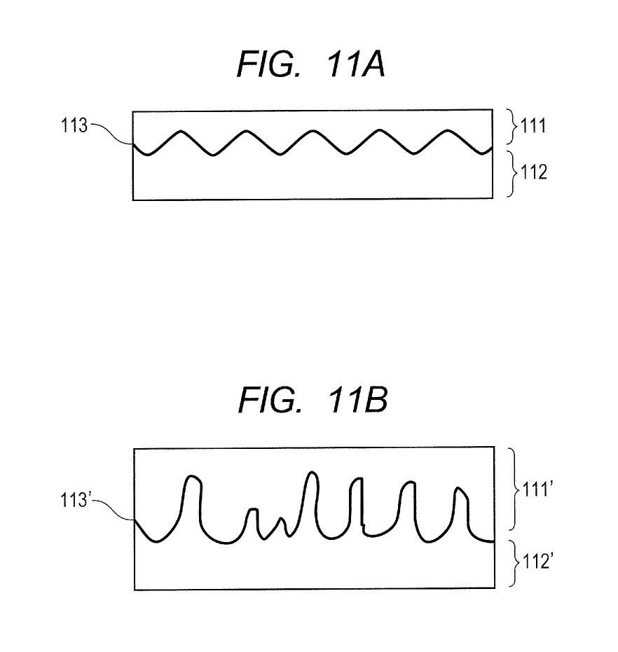

The object evaluating apparatus may be applied to, for example, evaluation of skin of a person. An epidermis-dermis interface of skin of a person has a concavo-convex shape. It is known that the reason is that the concavo-convex shape of the epidermis-dermis interface has an effect in that the concavo-convex shape allows a surface area of the interface to be widened to transfer much nutrition or oxygen, or a person easily feels displacement by protrusions to have a sensitive sense of touch. It is generally known that the concavo-convex shape of the epidermis-dermis interface is changed according to a disease, such as eczema, or a health condition (see FIGS. 11A and 11B). FIG. 11A is a schematic diagram of skin in a normal state, and FIG. 11B is a schematic diagram of skin in a disease (herein, psoriasis) state. Here, 111 and 111′ represent epidermis, 112 and 112′ represent dermis, and 113 and 113′ represent epidermis-dermis interfaces. Accordingly, when a change in the concavo-convex shape of the epidermis-dermis interface according to the disease or the health condition of the skin is used, the disease or the health condition of the skin may be estimated by the object evaluating apparatus. For example, reference data related to a relation between a disease or a health condition of skin and roughness information on an internal interface (epidermis-dermis interface) is pre-memorized in a memory means, such as a memory, in the object evaluating apparatus. A disease or a health condition of skin may be estimated by comparing the reference data with measured data (the roughness information on the internal interface (epidermis-dermis interface)) of the target skin for an examination.

It is determined that an electromagnetic wave of a terahertz band is appropriate to the application. The reason is that a frequency of a terahertz band or higher is preferable in order to obtain depth resolution capable of determining a structure (an order of 10 μm to 1 mm) of a degree of the skin, and a frequency of a terahertz band or lower is preferable in order to reduce influence of a smaller concavo-convex shape of skin surface or scattering by each cell. It is a matter of course that electromagnetic waves of other frequencies may also be used. The estimation of a disease and the like may be performed by simultaneously using various measurement methods, such as electromagnetic waves or ultrasonic waves of a plurality of frequencies.

The present object evaluating apparatus may be applied as an endoscope. In this case, a configuration inducing an electromagnetic wave pulse to an observation position inside a body by substituting a waveguide part of an electromagnetic wave pulse (or a waveguide part of an excitation light pulse) with a waveguide fiber, and the like may be conceived. As described above, the object evaluating apparatus of the present exemplary embodiment may be used in medical and cosmetic fields, or other fields, such as an examination of an industrial product.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-037487, filed Feb. 23, 2012, and Japanese Patent Application No. 2013-015053, filed Jan. 30, 2013, which are hereby incorporated by reference herein in their entirety.

What is claimed is:

1. A roughness evaluating apparatus, comprising:
a generating unit configured to generate an electromagnetic wave pulse;
a detecting unit configured to detect the electromagnetic wave pulse from a sample to which the electromagnetic wave pulse is irradiated;
a time waveform calculating unit configured to calculate a time waveform of the electromagnetic wave pulse from the sample detected by the detecting unit; and
a processing unit configured to obtain roughness information on an internal interface of the sample from the time waveform of the electromagnetic wave pulse,
wherein the processing unit extracts a part corresponding to the internal interface in the time waveform of the electromagnetic wave pulse from the time waveform of the electromagnetic wave pulse to obtain the roughness information on the internal interface.

2. The roughness evaluating apparatus according to claim 1, wherein the processing unit processes the part to correct influence of a material through which the electromagnetic wave pulse passes.

3. The roughness evaluating apparatus according to claim 1, wherein the processing unit obtains information on at least one of a refractive index, an absorption coefficient, and a shape of a material through which the electromagnetic wave pulse passes by extracting a part of the electromagnetic pulse reflected from a surface other than the internal interface, and
the processing unit processes the part using the information.

4. The roughness evaluating apparatus according to claim 1, further comprising:
a database storing information on at least one of a refractive index, an absorption coefficient, and a shape of a material through which the electromagnetic wave pulse passes in advance,
wherein the processing unit processes the part by using the information.

5. The roughness evaluating apparatus according to claim 1, wherein the processing unit corrects the part using information on at least one of a refractive index, an absorption coefficient, and a shape of a material through which the electromagnetic wave pulse passes.

6. The roughness evaluating apparatus according to claim 1, wherein the processing unit obtains the roughness information on the internal interface by using a spectrum of a reflection component of the electromagnetic wave pulse from the internal interface.

7. The roughness evaluating apparatus according to claim 6, wherein the processing unit compares information on the part corresponding to the internal interface in the time waveform of the electromagnetic wave pulse with reference data to evaluate roughness of the internal interface, and
the reference data includes data related to a relation between the roughness of the internal interface and the spectrum of the reflection component of the electromagnetic wave pulse.

8. The roughness evaluating apparatus according to claim 6, wherein the processing unit corrects the part using an absorption coefficient of a material through which the electromagnetic wave pulse passes.

9. The roughness evaluating apparatus according to claim 1, wherein the detecting unit detects the electromagnetic wave pulse incident to or reflected from the sample at a plurality of angles, and
the processing unit obtains the roughness information on the internal interface from a reflection angle distribution of the electromagnetic wave pulse.

10. The roughness evaluating apparatus according to claim 9, wherein the processing unit compares information on the part corresponding to the internal interface in the time waveform of the electromagnetic wave pulse with reference data to evaluate roughness of the internal interface, and
the reference data includes data related to a relation between the roughness of the internal interface and the reflection angle distribution of the electromagnetic wave pulse.

11. The roughness evaluating apparatus according to claim 9, wherein the processing unit corrects a reflection angle of the electromagnetic wave pulse using information on at least one of a refractive index, an absorption coefficient, and a shape of a material through which the electromagnetic wave pulse passes.

12. An object evaluating apparatus, comprising:
a generating unit configured to generate an electromagnetic wave pulse;
a detecting unit configured to detect the electromagnetic wave pulse from a sample to which the electromagnetic wave pulse is irradiated;
a time waveform calculating unit configured to calculate a time waveform of the electromagnetic wave pulse from the sample detected by the detecting unit; and
a processing unit configured to obtain roughness information on an internal interface of the sample from the time waveform of the electromagnetic wave pulse,
wherein the processing unit extracts a part corresponding to the internal interface in the time waveform of the electromagnetic wave pulse from the time waveform of the electromagnetic wave pulse to obtain the roughness information on the internal interface and information other than the roughness.

13. The object evaluating apparatus according to claim 12, wherein the processing unit obtains the information other than the roughness by correcting influence of the internal interface exerted on the electromagnetic wave pulse by using the obtained roughness information on the internal interface.

14. The object evaluating apparatus according to claim 12, wherein the electromagnetic wave pulse includes an electromagnetic wave pulse of a frequency of a terahertz band,
the processing unit estimates a disease or a health condition of skin by comparing the obtained roughness information on the internal interface and reference data, and
the reference data includes data related to a relation between the disease or the health condition of the skin and the roughness information on the internal interface.

15. A roughness evaluating method of obtaining roughness information on an internal interface of a sample by using an electromagnetic wave pulse, the roughness evaluating method comprising:
irradiating an electromagnetic wave pulse to a sample;
calculating a time waveform by detecting the electromagnetic wave pulse from the sample;
extracting a part corresponding to the internal interface in the time waveform of the electromagnetic wave pulse from the time waveform of the electromagnetic wave pulse; and
obtaining the roughness information on the internal interface of the sample from the extracted part of the time waveform.

16. The roughness evaluating apparatus according to claim 15, further comprising:
before obtaining the roughness information, processing the part corresponding to the internal interface in the time waveform of the electromagnetic wave pulse so as to correct influence of a material other than the internal interface.
